(19) United States
(12) Patent Application Publication
(10) Pub. No.: US 2019/0272074 A1
(43) Pub. Date: Sep. 5, 2019

(54) A SENSOR AND A DISPLAY AND APPARATUS AND METHODS FOR MANUFACTURING THEM

(71) Applicant: M-SOLV LIMITED, Oxford, Oxfordshire (GB)

(72) Inventor: Adam North BRUNTON, Oxford (GB)

(73) Assignee: M-SOLV LIMITED, Oxford, Oxfordshire (GB)

(21) Appl. No.: 16/308,626

(22) PCT Filed: May 25, 2017
(86) PCT No.: PCT/GB2017/051486

§ 371 Date: Dec. 10, 2018

(30) Foreign Application Priority Data
Jun. 17, 2016 (GB) 1610645.2

(51) Int. Cl. G06F 3/041

(52) U.S. Cl. CPC G06F 3/04144; G06F 2203/04102; G06F 2203/04103

(57) ABSTRACT

Methods and apparatus for manufacturing a sensor are disclosed. In one arrangement, a method comprises forming first and second electrodes on a substrate. An electrically functional layer is applied to connect the first electrode to the second electrode. The applying of the electrically functional layer comprises at least a first step in which a composition comprising a carrier fluid and an electrically functional material is applied in a first pattern comprising a plurality of first sub-regions.

This invention relates to providing a sensor, particularly a force sensitive unit or other sensor for a human-machine interface such as a display, for example a sensor that is able to detect a magnitude of a force applied to a region on the display, for example by a finger or stylus pressed against a viewing surface of the display.

Consumer electronics devices such as computers, tablets, phones and watches commonly comprise a touch sensitive screen which is able to detect a location of one or more touches to the screen. There is increasing interest in additionally providing the ability to detect forces associated with touches to the screen.

Numerous techniques have been used to implement force detection in the past, typically involving capacitive sensors or piezoelectric devices. It has proved to be challenging, however, to achieve an acceptable combination of reliability and low cost of manufacture.

A promising approach is based on applying nanoparticles between electrodes to form a nanoparticle-based resistive strain gauge. When force is applied to the nanoparticles the resistance between the electrodes changes as a function of the applied force, thereby providing a measure of the force. This assembly can be manufactured at relatively low cost and can advantageously be applied to both rigid and flexible substrates. Variability in the assembly of nanoparticles can however cause variability in the response of the force sensor, leading to inconsistencies between different sensors.

It is an object of the invention to provide sensors which can be manufactured reliably, at low cost, and with consistent performance properties.

According to an aspect of the invention, there is provided a method of manufacturing a sensor, comprising: forming a first electrode and a second electrode on a substrate; and applying an electrically functional layer to connect the first electrode to the second electrode, wherein: the applying of the electrically functional layer comprises at least a first step in which a composition comprising a carrier fluid and an electrically functional material is applied in a first pattern comprising a plurality of first sub-regions; and each of two or more of the first sub-regions is separated from all other first sub-regions when viewed perpendicularly to the substrate; and/or each of two or more of the first sub-regions is connected to one or more other first sub-regions when viewed perpendicularly to the substrate and a shortest line of contact between the first sub-region and each of the one or more other first sub-regions connected to the first sub-region is less than 20% of the length of an outer boundary line of the first sub-region when viewed perpendicularly to the substrate.

The inventors have found that applying the composition in plural sub-regions reduces the extent to which the electrically functional material can migrate and accumulate inhomogeneously during evaporation of the carrier fluid, thereby achieving more uniform and repeatable deposition of the electrically functional material than alternative approaches which deposit all of the electrically functional material in a single continuous region. The electrical properties of the electrically functional layer are therefore more predictable and regular. Variation in properties between different sensors is reduced.

In an embodiment, the applying of the electrically functional layer comprises a second step, subsequent to the first step, in which the composition comprising the carrier fluid and the electrically functional material is applied in a second pattern comprising a plurality of second sub-regions.

The inventors have found that depositing the electrically functional material in multiple steps in this manner makes it possible to position different sub-regions further apart from each other in each step, thereby facilitating avoidance of migration of the electrically functional material between different sub-regions during evaporation of the carrier fluid, while at the same time allowing a high degree of coverage by the electrically functional layer after all steps have been completed. Carrier fluid can mostly or completely evaporate between different steps.

In an embodiment, the electrically functional layer comprises conductive nanoparticles, optionally configured such that the dominant factor determining resistivity within the electrically functional layer is quantum tunnelling between the conductive nanoparticles. The inventors have found that configuring the electrically functional layer in this way provides particularly high sensitivity to applied forces.

According to an alternative aspect, there is provided a sensor comprising: a first electrode and a second electrode on a substrate; and an electrically functional layer connecting the first electrode to the second electrode, the electrically functional layer forming a pattern comprising a plurality of sub-regions, wherein: each of two or more of the sub-regions is separated from all other sub-regions when viewed perpendicularly to the substrate; and/or each of two or more of the sub-regions is connected to one or more other sub-regions when viewed perpendicularly to the substrate and a shortest line of contact between the sub-region and each of the one or more other sub-regions connected to the sub-region is less than 20% of the length of an outer boundary line of the sub-region when viewed perpendicularly to the substrate.

The invention will now be further described, by way of example, with reference to the accompanying drawings, in which:

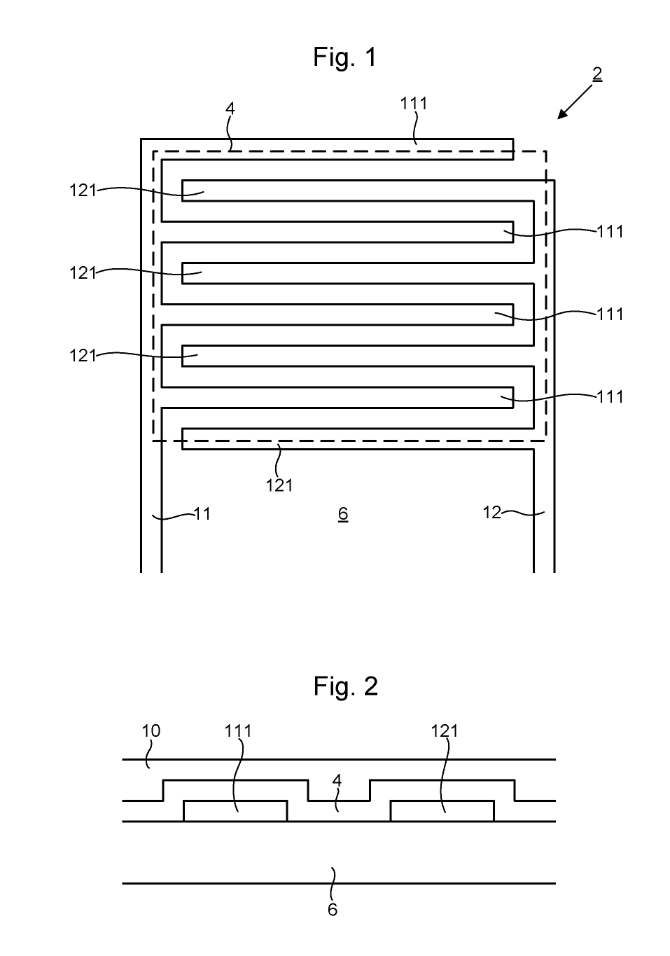

FIG. 1 is a schematic top view of a sensor according to an embodiment;

FIG. 2 is a schematic side sectional view of a portion of the sensor of FIG. 1;

FIG. 3 is a schematic side sectional view of a portion of a sensor of the type shown in FIG. 1 according to an alternative embodiment;

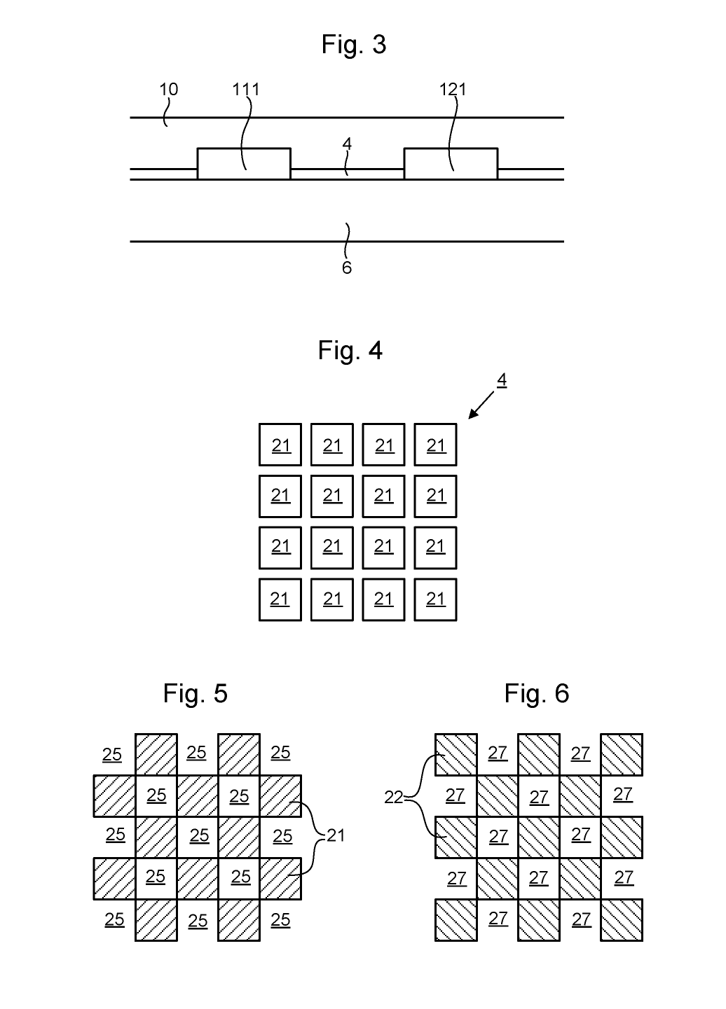

FIG. 4 depicts an example first pattern of a composition of a carrier fluid and an electrically functional material viewed perpendicularly to the substrate;

FIG. 5 depicts an alternative first pattern viewed perpendicularly to the substrate;

FIG. 6 depicts an example second pattern of a composition of a carrier fluid and an electrically functional material that is complementary to the first pattern of FIG. 5;

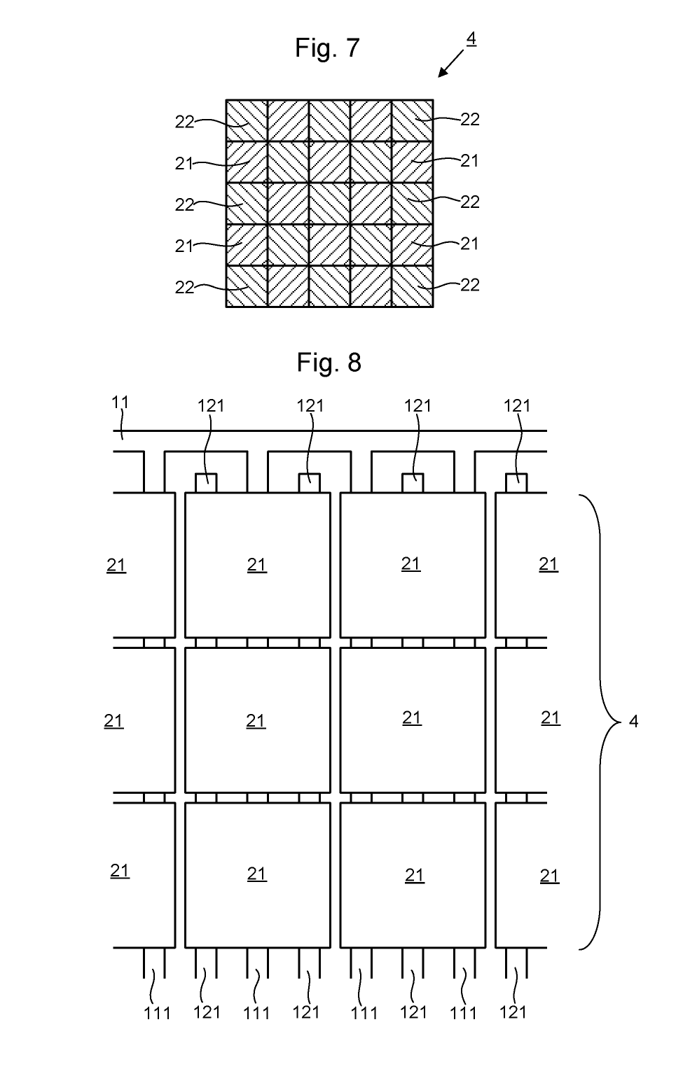

FIG. 7 depicts the result of applying the first pattern of FIG. 5 and, subsequently, the second pattern of FIG. 6;

FIG. 8 is a schematic top view of a portion of a sensor showing first sub-regions of the composition of the carrier fluid and electrically functional material that each overlap with both of the first and second electrodes;

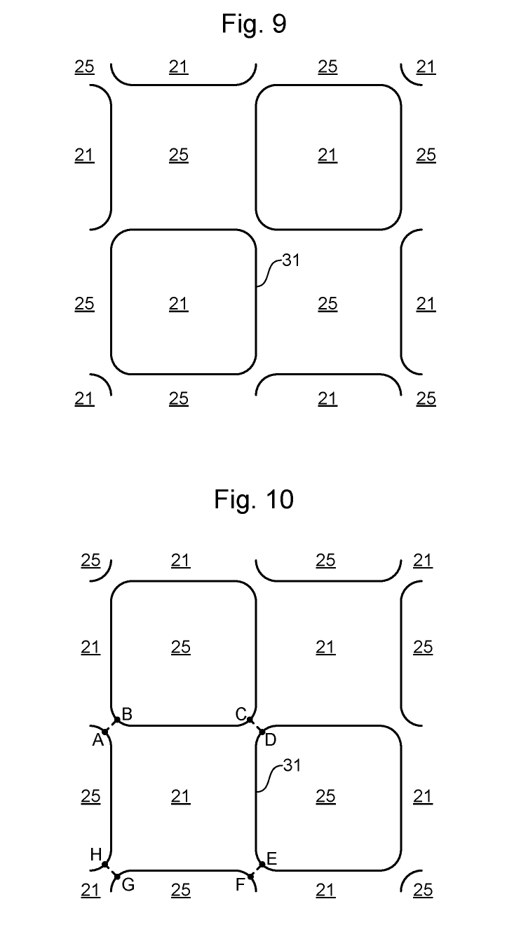

FIG. 9 depicts a portion of a first pattern or a second pattern of the type shown in FIG. 5 or 6, in which each sub-region is separated from all other sub-regions;

FIG. 10 depicts a portion of a first pattern or a second pattern of the type shown in FIG. 5 or 6, in which each sub-region is connected to neighbouring sub-regions at its corners; and

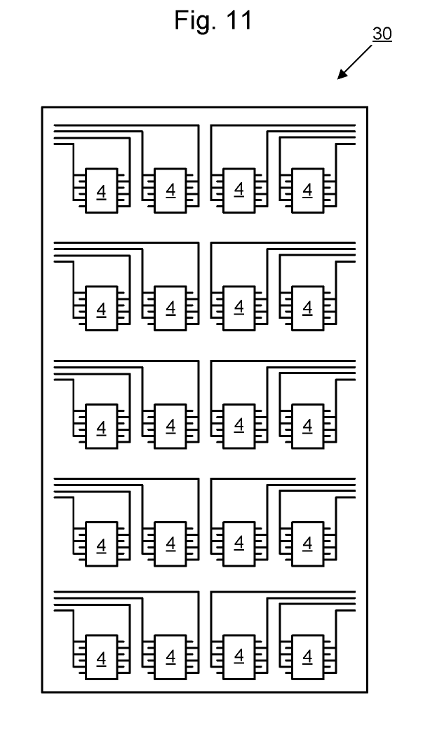

FIG. 11 is a schematic top view of a display comprising a plurality of sensors.

In an embodiment, a method of manufacturing a sensor 2 is provided. Example sensors 2 are depicted in FIGS. 1-3. In an embodiment, the sensor 2 comprises a force sensitive unit. The force sensitive unit may form part of a human-machine interface, for example a display 30 (as depicted in FIG. 11 for example), for example a touch sensitive display. Alternatively or additionally, the sensor 2 may be a capacitive sensor or other sensor 2. The sensor 2 may comprise interdigitated electrodes.

The method comprises forming a first electrode 11 and a second electrode 12 on a substrate 6. Typically the substrate 6 will be formed from an insulating material and/or covered with an insulating material, such that the first and second electrodes 11, 12 are in contact with the substrate 6 via insulating material. The first electrode 11 and the second electrode 12 may be formed in a variety of different ways known to the skilled person, for example by depositing a conducting material onto the substrate in a desired pattern and/or applying a patterning process subsequent to the deposition to provide the required pattern. The first electrode 11 and the second electrode 12 may be formed by laser patterning of a conductive layer such as a metal or indium tin oxide (ITO), for example. In the particular example shown in FIG. 1 the first electrode 11 comprises a plurality of parallel fingers 111, the second electrode 12 comprises a plurality of parallel fingers 121, and the plurality of parallel fingers 11 of the first electrode 11 and the plurality of parallel fingers 121 of the second electrode 12 interlock with each other, forming a so-called interdigitated pattern. The invention is not limited to this particular arrangement however.

The method further comprises applying an electrically functional layer 4 to connect the first electrode 11 to the second electrode 12. The electrically functional layer 4 may take various forms. In an embodiment the electrically functional layer 4 is configured so that forces applied to the electrically functional layer 4 change an electrical property of the electrically functional layer 4. The change in the electrical property may be such that it can be detected using standard electronics connected to the first electrode 11 and the second electrode 12 (e.g. by monitoring a relationship between a potential difference applied between the first electrode 11 and the second electrode 12 and a current flowing between the first electrode 11 and the second electrode 12). In an embodiment, the electrically functional layer 4 is configured so that flexing of the substrate 6 (i.e. a change in shape of the substrate 6, such as bending of the substrate 6) changes an electrical property of the electrically functional layer 4. Thus, for example, where a force is applied to a display 30 comprising the sensor 2 that is such as to cause flexing of the substrate 6 in the region of the sensor 2, this can be detected by electronics connected to the first electrode 11 and the second electrode 12.

In an embodiment, the change in the electrical property comprises a change in the resistivity of the electrically functional layer 4 and therefore in the resistance of an electrical path between the first electrode 11 and the second electrode 12. Alternatively or additionally, the change in the electrical property comprises a change in the dielectric constant of the electrically functional layer 4 and therefore in the capacitive properties of an electrical path between the first electrode 11 and the second electrode 12. The detection of the change in the electrical property can be used to determine the magnitude of a force applied to the sensor 2.

In an embodiment the electrically functional layer comprises conductive nanoparticles. The conductive nanoparticles may be configured so that the dominant factor determining resistivity within the electrically functional layer is quantum tunnelling between the conductive nanoparticles. Electrically functional layers of this type have been found to be particularly sensitive to applied forces, thereby providing high sensitivity. Use of such materials makes it possible to distinguish more reliably between different levels of force. Alternatively or additionally, use of such materials makes it possible to use substrates which are more rigid because smaller changes in the shape of the substrate can be detected reliably. Devices can therefore be made more robust.

The electrically functional layer comprising conductive nanoparticles may comprise composites of metals and non-conducting elastomeric binders, for example combinations of polymer composites with elastic, rubber-like properties (e.g. elastomers), and metal particles such as nickel. The electrically functional layer can be provided in opaque or transparent form. The electrically functional layer may be configured such that in the absence of pressure the conductive nanoparticles are too far apart to conduct electricity significantly. An applied pressure can force the conductive nanoparticles close enough together that quantum tunnelling can occur to a significant extent across the insulating material between the conductive elements. In contrast to a classical situation where electrical resistance would typically vary linearly with distance, the variation in a resistance dominated by quantum tunnelling is expected to be exponential. This exponential rather than linear variation provides the basis for the high sensitivity.

The applying of the electrically functional layer 4 comprises at least a first step in which a composition comprising a carrier fluid and an electrically functional material is applied in a first pattern comprising a plurality of first sub-regions 21. In an embodiment the first step is the only step of applying the electrically functional layer 4 and is effective for applying all of the electrically functional layer 4 needed to provide the desired connection between the first electrode 11 and the second electrode 12 (thus, the first sub-regions 21 are the only sub-regions 21 in such an embodiment). An example of such a first pattern is shown in FIG. 4. In other embodiments the first step is just one of a plurality of steps (e.g. two steps, three steps, or more steps) used to provide the electrically functional layer 4. Examples of a first pattern and a second pattern used in two different steps of such a multi-step process are shown respectively in FIGS. 5 and 6. Either or both of the first pattern and the second pattern (or indeed any further pattern) may be applied multiple times to build up a desired thickness of the electrically functional material.

In an embodiment, the first pattern comprising the plurality of first sub-regions 21 is formed at the same time that the composition comprising the carrier fluid and the electrically functional layer first contacts the first electrode and the second electrode, prior to any later evaporation of the carrier fluid or movement of the composition. In some embodiments, for example as shown in FIG. 2, structure on an upper side of the substrate 6, such as the first electrode 11 and the second electrode 12, will not significantly disrupt the positioning of the electrically functional material in the composition during evaporation of the carrier fluid. The electrically functional material will be deposited in a pattern which is substantially identical to the first pattern after evaporation of the carrier fluid. However, in other embodiments structure on the upper side of the substrate 6 may cause movement of the electrically functional material after the composition first contacts the first electrode 11 and the second electrode 12. For example, as shown in the example arrangement of FIG. 3, where the first electrode 11 and the second electrode 12 are relatively high (thick), the electrically functional material may preferentially fall into valleys between the first electrode 11 and the second electrode 12 during evaporation of the carrier fluid, such that less of the electrically functional material, or substantially no electrically functional material, is left on top of the first electrode 11 and/or second electrode 12 after the carrier fluid has evaporated. In this case a pattern formed by the electrically functional material after evaporation of the carrier fluid may be substantially different to the first pattern.

In an embodiment, each of two or more of the first sub-regions 21 (optionally all of the first sub-regions) is separated from (i.e. not connected to) all other first sub-regions 21 when viewed perpendicularly to the substrate 6. An example of such an arrangement is shown in FIG. 4. Each first sub-region 21 is surrounded by a region in which no material of the electrically functional layer 4 is present. The inventors have found that this arrangement reduces the scale of variations in the electrically functional layer 4 caused by the coffee ring effect relative to an alternative approach in which all of the electrically functional layer 4 is formed in a single continuous region. The coffee ring effect causes inhomogeneous deposition of particles due to differential evaporation rates across the deposited composition comprising the carrier fluid and the electrically functional material. Liquid evaporating from the edge is replenished by liquid from the interior, resulting in an edgeward flow during evaporation and a disproportionate accumulation of the electrically functional material towards the edges of the deposited composition. Restricting the deposited composition to discrete regions (the first sub-regions 21) constrains the electrically functional material to remain within those discrete regions and prevents migration of electrically functional material over longer distances. The electrical properties of the electrically functional layer 4 are therefore more predictable and regular. Variation in properties between different, nominally identical sensors 2 is reduced.

In an embodiment each of one or more of the first sub-regions 21 overlaps with a portion of the first electrode 11 and with a portion of the second electrode 12. An example configuration of this type is depicted in FIG. 8. Thus, even where there are gaps between individual first sub-regions 21, a continuous connection is still made between the first electrode 11 and the second electrode 12 through each of the one or more first sub-regions 21 that overlap with both of the first and second electrodes 11, 12.

In an embodiment, the applying of the electrically functional layer 4 comprises a second step, subsequent to the first step. In the second step the composition comprising the carrier fluid and the electrically functional material is applied in a second pattern. The second pattern comprises a plurality of second sub-regions 22. In an embodiment, at least a majority of the carrier fluid applied during the first step evaporates before the second step is performed. Thus, the second sub-regions 22 can be applied directly adjacent to the first sub-regions 21, or even overlapping with the first sub-regions 21, without any significant risk of a large scale coffee ring effect. The electrically functional material cannot move across regions in which no significant carrier fluid is present.

In an embodiment, the second pattern is substantially complementary to the first pattern, such that the second sub-regions 22 substantially fill gaps 25 between the first sub-regions 21 (and the first sub-regions 21 substantially fill gaps 27 between the second sub-regions 22). Example first and second patterns of this type are shown in FIGS. 5 and 6 respectively. The result of carrying out the first step using the first pattern of FIG. 5 and, subsequently, the second step using the second pattern of FIG. 6 is depicted in FIG. 7. As can be seen the combination of the first and second steps provides substantially continuous coverage over a relative large area, but without the risk of a coffee ring effect occurring over the whole of the large area. Any coffee ring effect can only happen within each of the first and second sub-regions 21, 22.

In an embodiment, at least a majority of the total surface area of the second sub-regions 22, when viewed perpendicularly to the substrate 6, does not overlap with any of the first sub-regions 21. The arrangement discussed above with reference to FIGS. 5-7 is an example of this type. Minimizing overlap helps to ensure uniform deposition of the electrically functional material.

In an embodiment, the first sub-regions 21 and the second sub-regions 22 have the same shape and tessellate with each other. This approach is simple to implement and achieves good space filling. In the example of FIGS. 5-7 the first sub-regions 21 and the second sub-regions 22 are square but any other tessellating shapes could be used. In other embodiments, a combination of first sub-regions 21 and/or second sub-regions 22 having different shapes from each other but still forming a tessellating pattern are used.

The use of tessellating shapes is not restricted to the case where a multi-step approach is used to apply the electrically functional layer. Even where only first sub-regions 21 are present (as in the example of FIG. 4), the first sub-regions 21 may all have the same shape and/or be configured to tessellate with each other. This approach is also simple to implement and provides good space filling. In other embodiments, a combination of first sub-regions 21 of different shapes forming a tessellated pattern are used.

In an embodiment, the first sub-regions 21 and the second sub-regions 22 are arranged in rows and columns and alternate with each other in each row and in each column. The chess board like example shown in FIG. 7 is an embodiment of this type.

FIGS. 9 and 10 are magnified views of a portion of a first pattern of the type discussed above with reference to FIG. 5 according to two different embodiments.

In the embodiment of FIG. 9, each of the first sub-regions 21 is isolated from all of the other sub-regions 21. Therefore, even at the corners of the first sub-regions 21, which most closely approach neighbouring first sub-regions 21, no contact occurs. This approach minimizes the coffee ring effect but requires accurate formation of the sub-regions 21 and/or slightly lower coverage by the electrically functional layer.

In an alternative embodiment, exemplified by FIG. 10, each of two or more of the first sub-regions 21 (optionally all of the first sub-regions 21) is connected to one or more other first sub-regions 21 when viewed perpendicularly to the substrate 6 and a shortest line of contact between the first sub-region 21 and each of the one or more other first sub-regions 21 connected to the first sub-region 21 is less than 20% of the length of an outer boundary line 31 of the first sub-region 21 when viewed perpendicularly to the substrate 6, optionally less than 10%, optionally less than 5%, optionally less than 2%, optionally less than 1%. In FIG. 10, the shortest line of contact between the first sub-region 21 shown in the lower-left of FIG. 8 and each of its first nearest neighbours (along the diagonals) are shown by the four broken lines A-B, C-D, E-F and G-H. The outer boundary line 31 comprises the whole boundary of the first sub-region, formed by lines A-B, B-C, C-D, D-E, E-F, G-H and H-A.

In an embodiment, the composition comprising the carrier fluid and the electrically functional material is applied using inkjet printing. The pattern formed by the composition at the time when the composition first contacts the first electrode and the second electrode (i.e. the time when the composition is applied by the printing) is defined by the inkjet printing process. The inkjet printing head (or heads) prints the composition in the desired pattern (e.g. the first pattern, second pattern, etc.). The inventors have found this approach to be efficient and flexible.

In an embodiment, one or more (optionally all) of the following are substantially transparent (e.g. have a transmittance of greater than 90%): the first electrode 11, the second electrode 12, the electrically functional layer 4, and the substrate 6. The substrate 6 may be formed from PET for example.

In an embodiment, the substrate 6 is flexible, for example to an extent which allows a deformation of the substrate 6 (without breaking of the substrate 6) sufficient to cause a significant (e.g. easily measurable) change in the electrically properties (e.g. resistivity and/or dielectric constant) of the electrically functional layer connecting together the first and second electrodes 11, 12.

In an embodiment, the applying of the electrically functional layer comprises heating the composition comprising the carrier fluid and the electrically functional material, after application of the composition, to promote evaporation of the carrier fluid. The heating may be applied via a chuck supporting the substrate 6 during the processing for applying the electrically functional layer, for example.

In an embodiment a protective cover layer 10 is provided subsequent to applying the electrically functional layer, as in the arrangements shown in FIGS. 2 and 3.

In an embodiment, the method is adapted to form a plurality of the sensors 2 at different locations on a display 30. Where the sensors are configured to measure force this allows force to be measured as a function of position on the display. An example display 30 comprising plural such sensors 2 is depicted schematically in FIG. 11.

1. A method of manufacturing a sensor, comprising:
forming a first electrode and a second electrode on a substrate; and
applying an electrically functional layer to connect the first electrode to the second electrode, wherein:
the applying of the electrically functional layer comprises at least a first step in which a composition comprising a carrier fluid and an electrically functional material is applied in a first pattern comprising a plurality of first sub-regions; and
each of two or more of the first sub-regions is separated from all other first sub-regions when viewed perpendicularly to the substrate; and/or each of two or more of the first sub-regions is connected to one or more other first sub-regions when viewed perpendicularly to the substrate and a shortest line of contact between the first sub-region and each of the one or more other first sub-regions connected to the first sub-region is less than 20% of the length of an outer boundary line of the first sub-region when viewed perpendicularly to the substrate,
wherein the applying of the electrically functional layer comprises a second step, subsequent to the first step, in which the composition comprising the carrier fluid and the electrically functional material is applied in a second pattern comprising a plurality of second sub-regions, and
wherein at least a majority of the surface area of the second sub-regions, when viewed perpendicularly to the substrate, does not overlap with any of the first sub-regions.

2. (canceled)

3. The method of claim 1, wherein the composition comprising the carrier fluid and the electrically functional material is applied using inkjet printing.

4. (canceled)

5. The method of claim 1, wherein the electrically functional layer is configured so that forces applied to the electrically functional layer change an electrical property of the electrically functional layer.

6. The method of claim 1, wherein the electrically functional layer is configured so that flexing of the substrate changes an electrical property of the electrically functional layer.

7. The method of claim 5, wherein the change in the electrical property comprises a change in the resistivity of the electrically functional layer and therefore in the resistance of an electrical path between the first electrode and the second electrode.

8. The method of claim 5, wherein the change in the electrical property comprises a change in the dielectric constant of the electrically functional layer and therefore in the capacitive properties of an electrical path between the first electrode and the second electrode.

9. The method of claim 1, wherein all of the first sub-regions are separated from all other first sub-regions when viewed perpendicularly to the substrate.

10. The method of claim 1, wherein each of one or more of the first sub-regions overlaps with a portion of the first electrode and with a portion of the second electrode.

11.-12. (canceled)

13. The method of claim 1, wherein the second pattern is substantially complementary to the first pattern such that the second sub-regions substantially fill gaps between the first sub-regions.

14. (canceled)

15. The method of claim 1, wherein the first sub-regions and the second sub-regions tessellate with each other.

16. (canceled)

17. The method of claim 1, wherein the electrically functional layer comprises conductive nanoparticles.

18. The method of claim 17, wherein the electrically functional layer comprising conductive nanoparticles is configured such that the dominant factor determining resistivity within the electrically functional layer is quantum tunnelling between the conductive nanoparticles.

19. The method of claim 1, wherein one or more of the following is substantially transparent: the first electrode, the second electrode, the electrically functional layer, and the substrate.

20. (canceled)

21. The method of claim 1, wherein the first pattern comprising the plurality of first sub-regions is formed at the same time that the composition comprising the carrier fluid and the electrically functional material first contacts the first electrode and the second electrode, prior to any later evaporation of the carrier fluid or movement of the composition.

22. A method of manufacturing a display comprising forming a plurality of sensors at different locations on the display, each sensor being manufactured using the method of claim 1.

23. An apparatus for manufacturing a sensor, the apparatus being configured to carry out the method of claim 1.

24. A sensor comprising:
a first electrode and a second electrode on a substrate; and
an electrically functional layer connecting the first electrode to the second electrode, the electrically functional layer forming a pattern comprising a plurality of sub-regions, wherein:
each of two or more of the sub-regions is separated from all other sub-regions when viewed perpendicularly to the substrate; and/or
each of two or more of the sub-regions is connected to one or more other sub-regions when viewed perpendicularly to the substrate and a shortest line of contact between the sub-region and each of the one or more other sub-regions connected to the sub-region is less than 20% of the length of an outer boundary line of the sub-region when viewed perpendicularly to the substrate,
wherein the plurality of sub-regions comprises a first pattern comprising a plurality of first sub-regions and a second pattern comprising a plurality of second sub-regions,
wherein at least a majority of the surface area of the second sub-regions, when viewed perpendicularly to the substrate, does not overlap with any of the first sub-regions, and
wherein each of plural of the sub-regions overlaps with a portion of the first electrode and the second electrode.

25. The sensor of claim 24, wherein the sensor comprises a force sensitive unit.

26. The sensor of claim 24, wherein the substrate is flexible.

27. The sensor of claim 24, wherein the electrically functional layer is configured so that forces applied to the electrically functional layer change an electrical property of the electrically functional layer that is measurable via the first electrode and the second electrode.

28. The sensor of claim 24, wherein the electrically functional layer is configured so that flexing of the substrate changes an electrical property of the electrically functional layer that is measurable via the first electrode and the second electrode.

29.-30. (canceled)

31. The sensor of claim 24, wherein all of the sub-regions are separated from all other sub-regions when viewed perpendicularly to the substrate.

32.-35. (canceled)

36. A display comprising a plurality of the sensors of claim 24, wherein each sensor is at a different position on the display.

37.-38. (canceled)
